(19) United States
(12) Patent Application Publication
(10) Pub. No.: US 2025/0194763 A1
(43) Pub. Date: Jun. 19, 2025

(54) Umbrella with dual arms to tighten and top fabric for clean look and ability to brand

(71) Applicant: Martin James Dotterweich, Escondido, CA (US)

(72) Inventor: Martin James Dotterweich, Escondido, CA (US)

(21) Appl. No.: 18/648,545

(22) Filed: Apr. 29, 2024

Related U.S. Application Data
(63) Continuation-in-part of application No. 17/580,438, filed on Jan. 20, 2022, now Pat. No. 11,969,064.
(60) Provisional application No. 63/140,139, filed on Jan. 21, 2021.

(51) Int. Cl. A45B 25/02; A45B 23/00; A45B 25/06; A45B 25/14; A45B 25/18; G09F 23/02

(52) U.S. Cl. CPC A45B 25/02; A45B 23/00; A45B 25/06; A45B 25/14; A45B 25/18; G09F 23/02; A45B 2023/0012

(57) ABSTRACT

Disclosed is an umbrella with dual arms to tighten a fabric or sheet material cover for a clean look and ability to brand. With the dual arms, or spokes, the framework can be created that is solid while operating in the manner of a traditional umbrella.

### CROSS-REFERENCE TO RELATED APPLICATIONS

See application data sheet.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The subject matter of this disclosure is in the field of umbrellas or parasols.

### Background of the Invention

An umbrella (rain shield) or parasol (sun shade) is a foldable canopy defined by a fabric-covered, hub-and-spoke frame coaxially situated at the top of a pole. FIG. 1 shows a traditional umbrella (1000) or parasol with a hub-and-spoke frame (1100). See U.S. Des. Pat. No. D652,615 (issued Jan. 12, 2012) to Paolucci. As shown in FIG. 1, in a popped-up configuration, the foldable spokes (1110) of the hub-and-spoke frame (1100) radiate from the top of the central pole (1200) so that the fabric-cover (1300) is stretched taut over the spokes (1110) to form a valanced canopy above the central pole (1200). In a collapsed configuration (not shown), the spokes (1110) are folded downward to the pole (1200) while the fabric cover (1300) slacks so that the cover can be wrapped closely around the spokes (1110) and central pole (1200).

Still referring to FIG. 1, the fabric cover (1300) is sewn onto the spokes (1100) so that the fabric (1300) will (a) fit tightly over the popped-up hub-and-spoke (1100) frame and b) slack to a flat and folded state over the collapsed hub-and-spoke frame (1100) and pole (1200). Suitably, the with fabric cover (1300) is provided with valances (1310) that are hemmed vertically at each end of the spoke (1110) so that the valances (1200) drape downward to screen the umbrella/parasol and the space beneath it. Typically, the valances (1310) are slack so that they umbrella/parasol may collapse properly.

The traditional umbrella frame and cover is not suitable for all situations. In most cases, for example, the umbrella/parasol spokes are often flimsy and the flimsiness causes the hub and spoke frame to be easily turned inside out when caught in the wind. Additionally, the cover's valances are slack and, as a result, flap in the wind which can make undesirable noise and can cause emblems or branding positioned on the valances to be obscured. So, there is a need for umbrellas/parasols that have sturdier frames and covers that have valances that can maintain their configuration.

### SUMMARY OF THE INVENTION

In view of the foregoing, an object of this specification is to disclose an umbrella/parasol frame with a cover that is sturdy and features valances that do not flap in the wind while folding in the traditional way. It is a further objective of this specification to disclose an umbrella or parasol with an improved look and appearance where the fabric cover is pulled taut over a solid framework that functions as a traditional umbrella or parasol frame. Suitably, the fabric creates a solid, “wrap around” look to the canopy and creates a tight fit so that the valance of the canopy are restricted from flapping in the wind.

In a preferred embodiment, the disclosed canopy frame maybe defined by a center pole with a top hub and a first set of spokes positioned at the top of the center pole, a bottom hub with a second set of spokes positioned at a midpoint of the center pole below the top hub, a first set of risers that connects the first set of spokes to the second set of spokes via the tips of each spoke, a second set of risers that connects the first set of spokes to the second set of spokes at a midpoint of the spokes, and a riser with ribs pivotably connected to a midpoint of the spokes.

Listing of prior art.

Here is a list of U.S. patent documents:
U.S. Pat. No. 364,987 by Burnett discloses an umbrella frame from the 1890s;
U.S. Pat. No. 744,476 by Burgess discloses an umbrella frame from the early 1900s;
U.S. Pat. No. 778,940 by Allen also discloses an umbrella frame from the 1900s;
U.S. Pat. No. 831,381 by Sawaya discloses yet another umbrella frame from the 1900s;
U.S. Pat. No. 1,036,142 by Parker discloses an umbrella frame from the 1910s;
U.S. Pat. No. 1,397,794 by Chase discloses an umbrella frame from the 1920s with reinforcement rods connected to the umbrella's ribs (col. 1:52-col. 2:60);
U.S. Pat. No. 1,628,539 by Grey discloses a “duplex umbrella” from the 1920s;
U.S. Pat. No. 1,908,453 by Schmidt discloses an umbrella frame from the 1930s; and,
U.S. Pat. No. 3,853,135 by Schafer discloses an umbrella frame from the 1970s.

Here is a list of Int'l patent documents:
CN2254657Y shows a double layer umbrella from the 1990s;
CN2363541Y shows an umbrella frame adapted for various moldings and is from the 2000s;
CN2528265Y shows an umbrella from the 2000s;
CN200994492Y shows an advertising double-layered umbrella with heavy curtain and is from the 2000s;
DE202004007086U1 shows an Umbrella from the 2000s;
JP3110689U shows a double layer umbrella from the 200s;
Int'l Pat. No. WO 2008/114305 by Degl'innocenti discloses “an umbrella type covering structure with ribs in the form of parallelogram linkages” from the 2000s;
CN202233472U from the 2010s shows a dual-layer sunshade and rainproof umbrella;
CN204091189U from the 2010s shows a double layer umbrella;
CN216627699U was filed Jan. 4, 2022 and shows a sun shade umbrella; and,
Int'l Pat. No. WO 2023/131039 was filed Dec. 29, 2022 and shows a sunshade umbrella.

These int'l patent applications are believed to either be cumulative of the older U.S. Patents listed above or not prior art under 35 U.S.C. § 102 & 103. For instance,

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a traditional umbrella or parasol; and,

FIG. 2 is an improved umbrella or parasol frame depicted in a collapsed configuration;

FIG. 3 is the improved umbrella or parasol frame depicted in a partially collapsed configuration;

FIG. 4A is the improved umbrella or parasol frame depicted in a partially popped-up configuration;

FIG. 4B is a side view of the improved umbrella or parasol frame of FIG. 4A;

FIG. 5A is bottom perspective view of the improved umbrella or parasol frame depicted in a popped-up configuration;

FIG. 5B is a bottom view the improved umbrella or parasol frame depicted in a popped-up configuration;

FIG. 5C is a side view the improved umbrella or parasol frame depicted in a popped-up configuration;

FIG. 5D is a top perspective view of the improved umbrella or parasol frame depicted in a popped-up configuration;

FIG. 5E is a zoom-in view of the improved umbrella or parasol frame depicted FIG. 5D;

FIG. 5F is a top view the improved umbrella or parasol frame depicted in a popped-up configuration;

FIG. 6A is bottom perspective view of the improved umbrella or parasol frame depicted in a popped-up configuration with a fabric cover;

FIG. 6B is a bottom view of the improved umbrella or parasol frame depicted in a popped-up configuration with a fabric cover;

FIG. 6C is a side view the improved umbrella or parasol frame depicted in a popped-up configuration with a fabric cover;

FIG. 6D is a top perspective view the improved umbrella or parasol frame depicted in a popped-up configuration with a fabric cover;

FIG. 6E is a top view the improved umbrella or parasol frame depicted in a popped-up configuration with a fabric cover;

FIG. 7 is the improved umbrella or parasol frame depicted in a popped up configuration and featuring an enlarged or extended riser;

FIG. 8 is the improved umbrella or parasol frame depicted in a popped up configuration and featuring an enlarged or extended riser;

FIG. 9 is the improved umbrella or parasol frame embodied for use in a cantilever style umbrella system, e.g., where the center pole of the umbrella frame is hung up under a cantilever rather than posted on top of an upright;

FIG. 10 is the improved umbrella or parasol frame with a square plan popped up and used in a traditional cantilever style umbrella system, e.g., where the center pole of the umbrella frame is hung up under a cantilever rather than posted on top of an upright;

FIG. 11 is the improved umbrella or parasol frame with a square plan collapsed and used in a traditional cantilever style umbrella system, e.g., where the center pole of the umbrella frame is hung up under a cantilever rather than posted on top of an upright;

FIG. 12 is a top view of the improved umbrella or parasol frame with a square plan used in a traditional cantilever style umbrella system, e.g., where the center pole of the umbrella frame is hung up under a cantilever rather than posted on top of an upright;

FIG. 13 is the improved umbrella or parasol frame with a popped up square plan used in a sliding cantilever style umbrella system, e.g., where the center pole of the umbrella frame is hung up under a cantilever rather than posted on top of an upright;

FIG. 14 is the improved umbrella or parasol frame with a collapsed square plan used in a sliding cantilever style umbrella system, e.g., where the center pole of the umbrella frame is hung up under a cantilever rather than posted on top of an upright;

FIG. 15 is the improved umbrella or parasol frame with a circular plan popped up and used in a traditional cantilever style umbrella system, e.g., where the center pole of the umbrella frame is hung up under a cantilever rather than posted on top of an upright;

FIG. 16 is the improved umbrella or parasol frame with a circle plan collapsed and used in a traditional cantilever style umbrella system, e.g., where the center pole of the umbrella frame is hung up under a cantilever rather than posted on top of an upright;

FIG. 17 is a top view of the improved umbrella or parasol frame with a circular plan used in a traditional cantilever style umbrella system, e.g., where the center pole of the umbrella frame is hung up under a cantilever rather than posted on top of an upright;

FIG. 18 is a top view of the improved umbrella or parasol frame with a canopy and a circular plan used in a traditional cantilever style umbrella system, e.g., where the center pole of the umbrella frame is hung up under a cantilever rather than posted on top of an upright;

FIG. 19 is the improved umbrella or parasol frame with a popped up circular plan used in a sliding cantilever style umbrella system, e.g., where the center pole of the umbrella frame is hung up under a cantilever rather than posted on top of an upright;

FIG. 20 is the improved umbrella or parasol frame with a collapsed circular plan used in a sliding cantilever style umbrella system, e.g., where the center pole of the umbrella frame is hung up under a cantilever rather than posted on top of an upright;

FIG. 21A is an alternate embodiment of the umbrella or parasol framework in a collapsed state;

FIG. 21B is the alternate embodiment of the umbrella or parasol framework in a popped up state;

FIG. 21C is a view of the pulley systems for operating the umbrella or parasol via an internal pull cord (2000) to pop-up or collapse the umbrella;

FIG. 21D is an alternate view of the pulley system for operating the umbrella or parasol;

FIG. 21E is an exploded view of a pulley network of the pulley system of FIGS. 21C and 21D;

FIG. 22A is another embodiment of the canopy where the first and second set of spokes are positioned close together and where the lower set of spokes feature Light Emitting Diodes (LEDs) for lighting purposes and where the spokes feature a sleeve that can be outfitted with advertisements or ornaments;

FIG. 22B is an illustration of the embodiment of FIG. 22A;

FIG. 22C is another illustration of an alternate embodiment of FIG. 22A;

FIG. 23 is a cross section of a pole with an internal pull cord;

FIG. 24 is another cross section of a pole with an internal pull cord;

FIG. 25 is a view of an umbrella;

FIG. 26 is another view of an umbrella;

FIG. 27 is another view of an umbrella;

FIG. 28 is another view of the umbrella; and,

FIG. 29 is a perspective view of a center pole with a pully system.

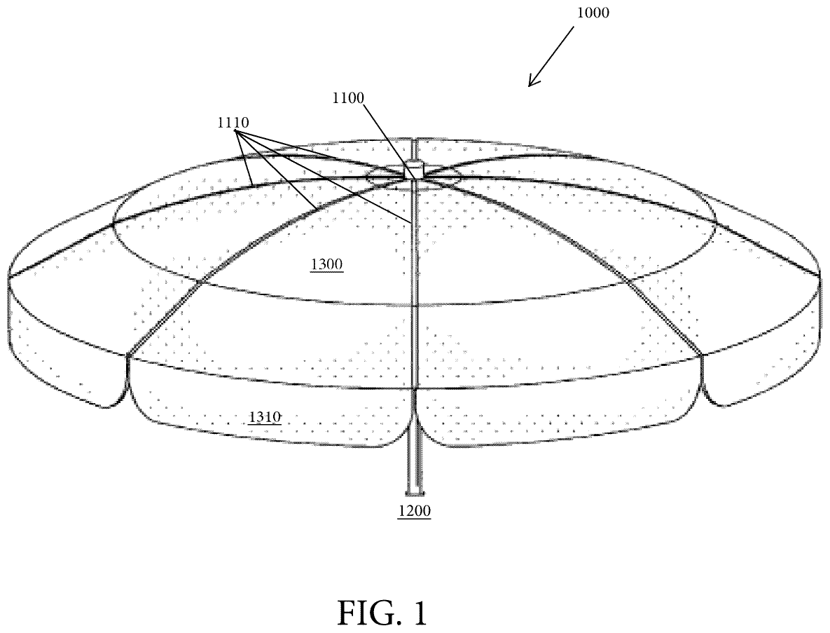

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFFERED EMBODIMENTS

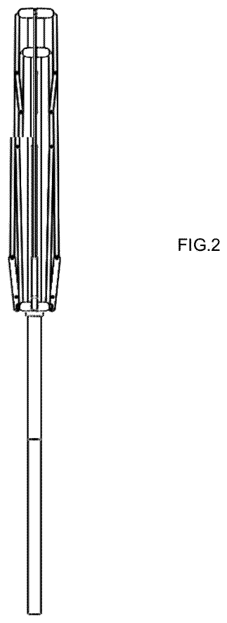

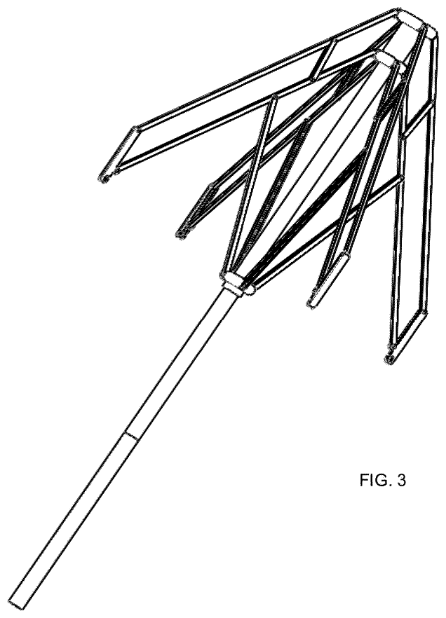

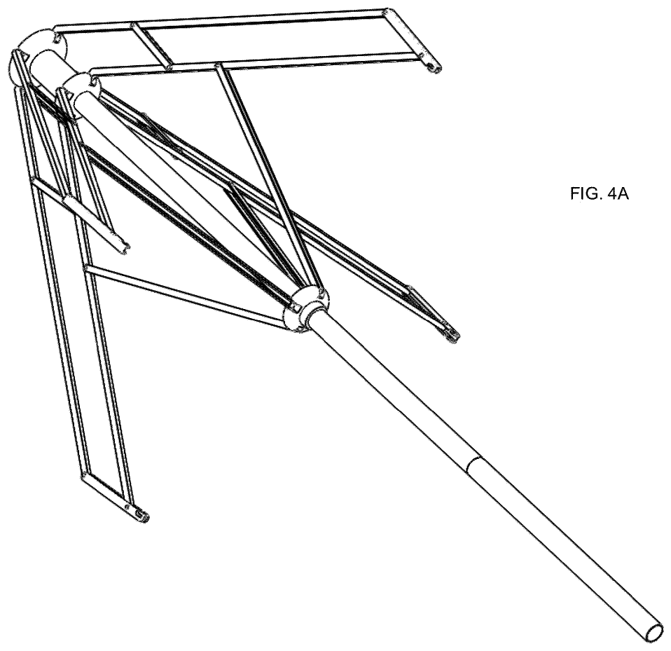

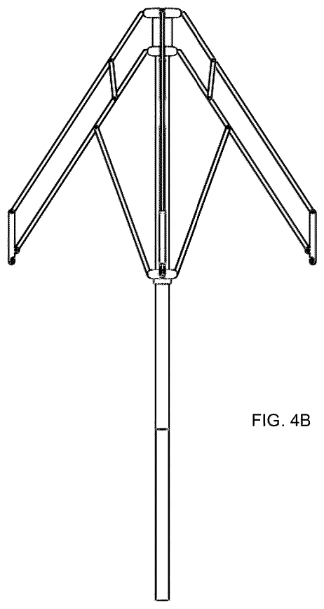

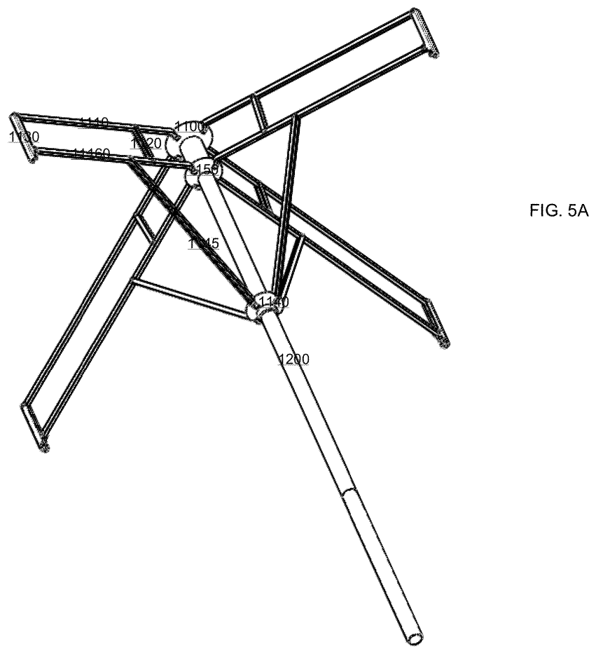

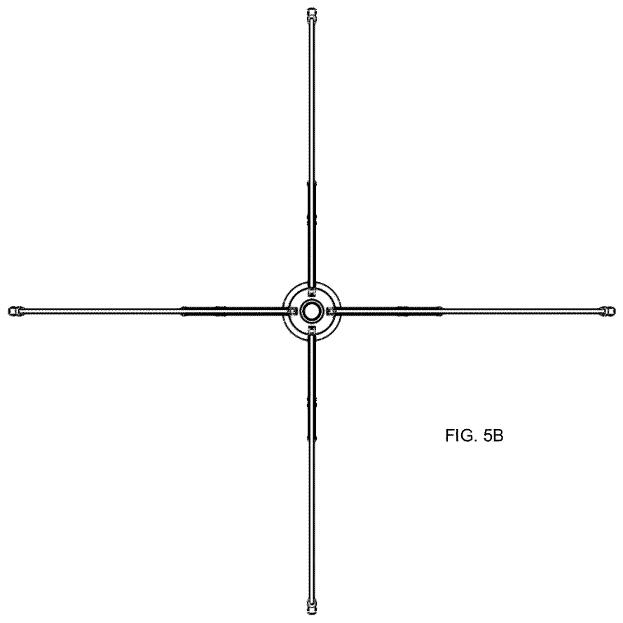

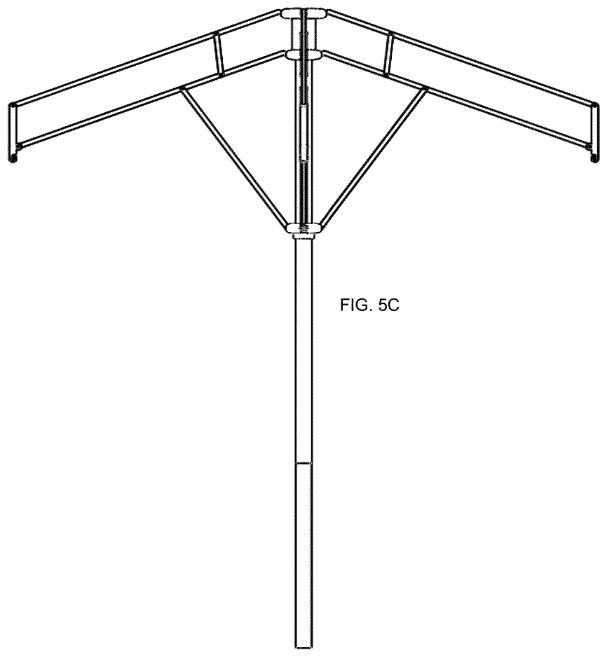

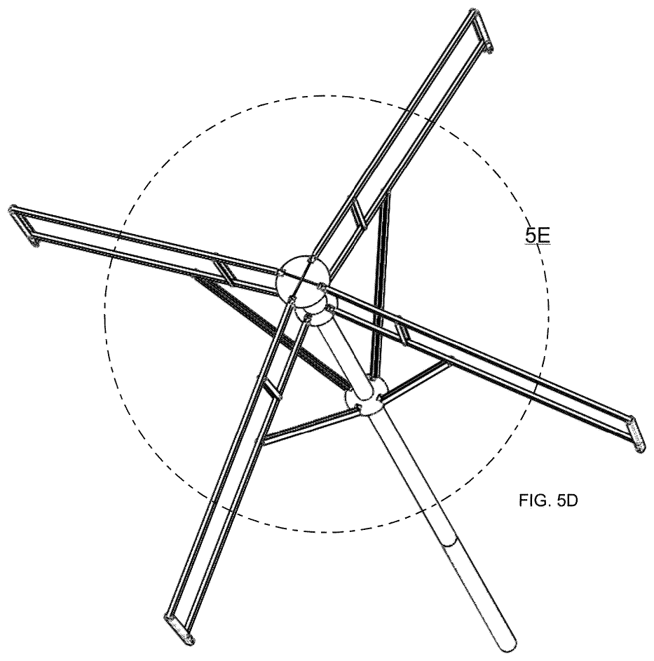

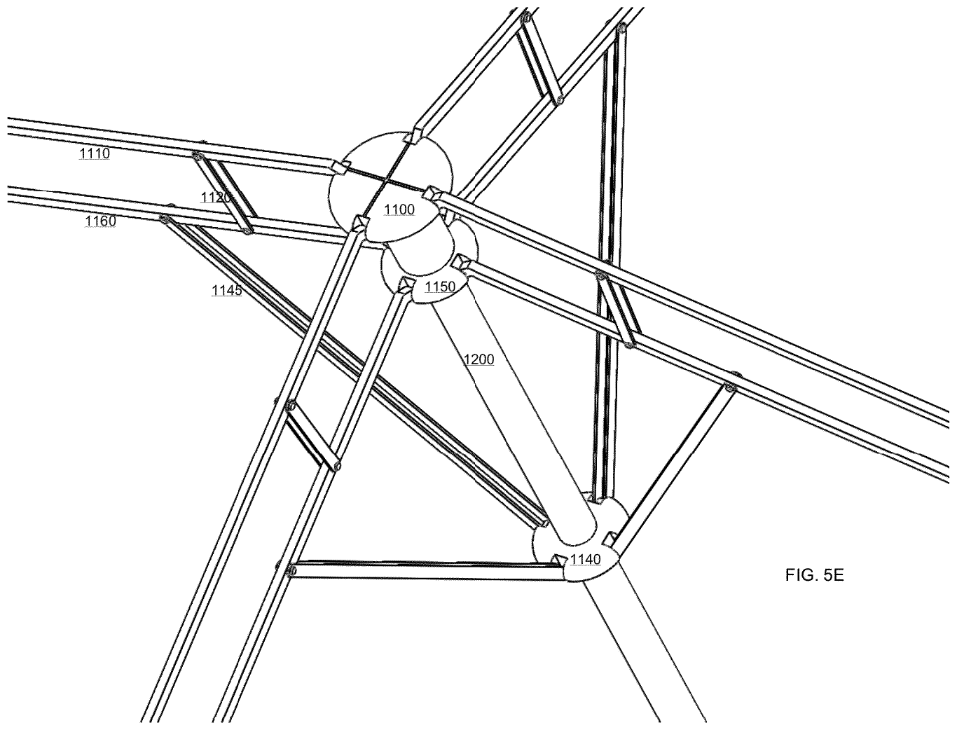

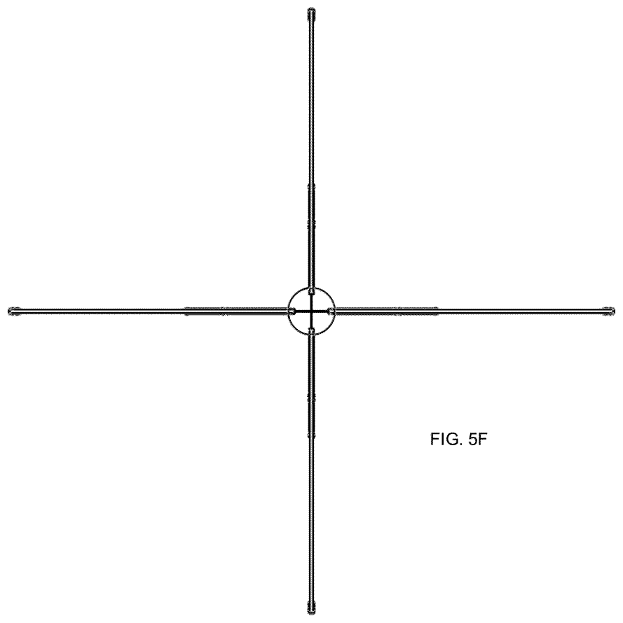

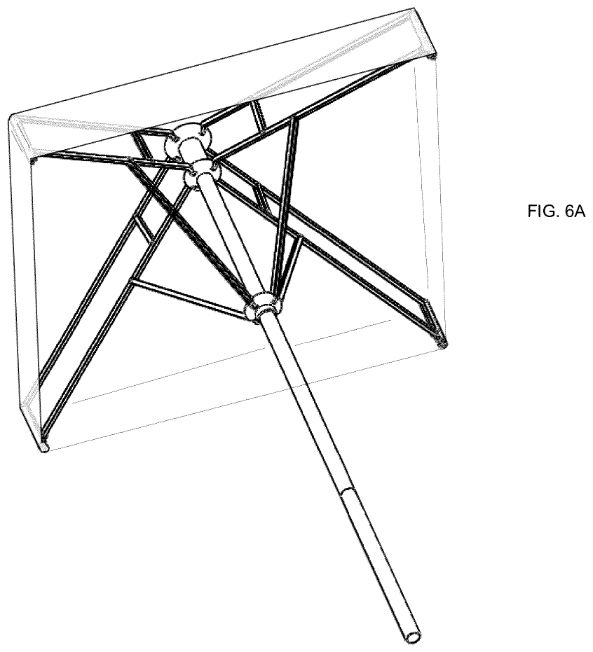

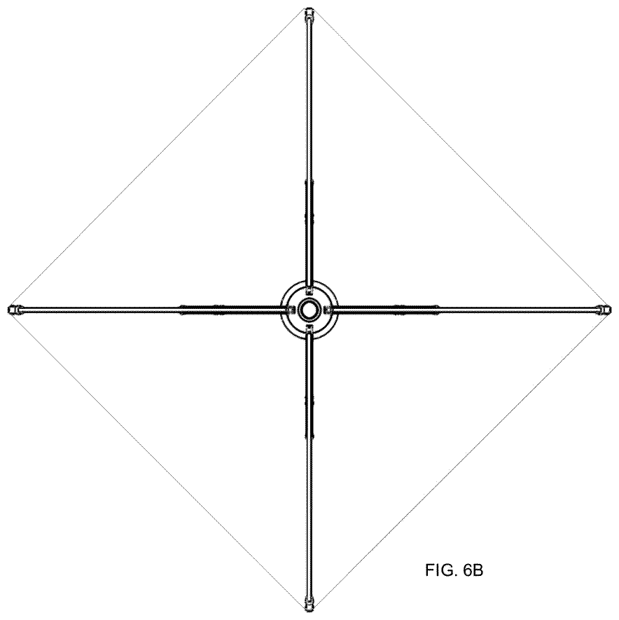

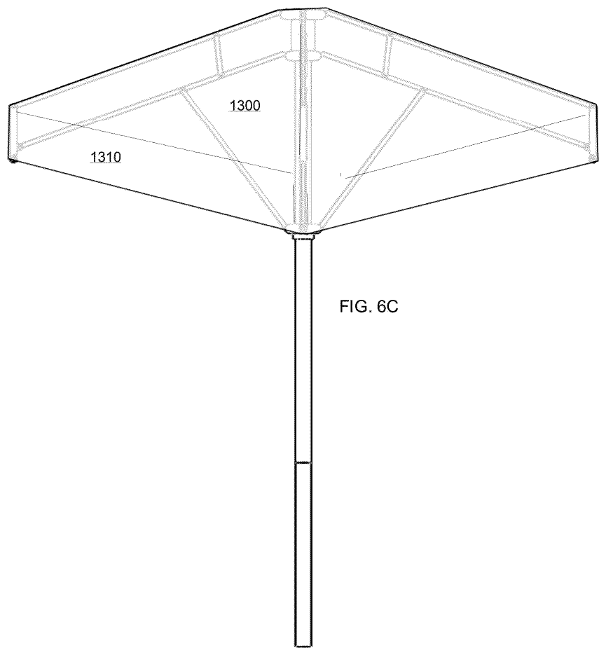

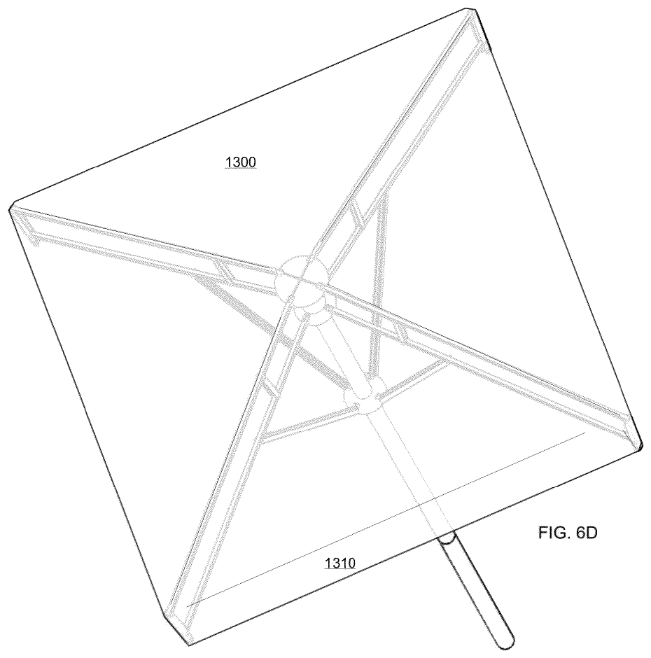

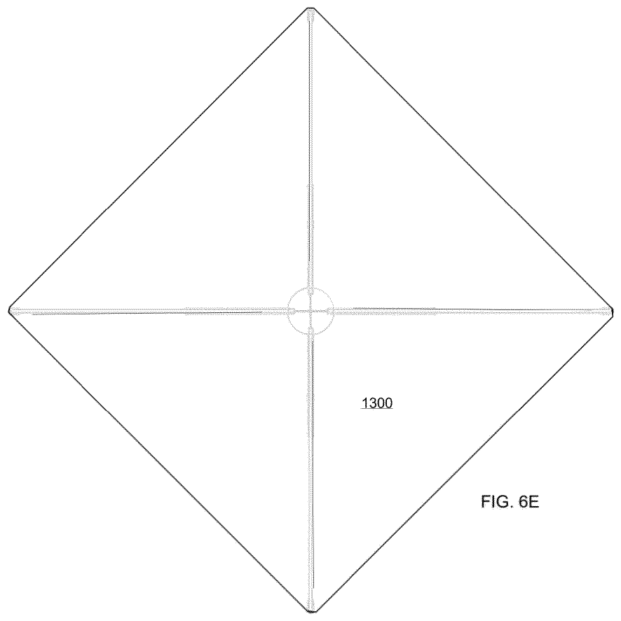

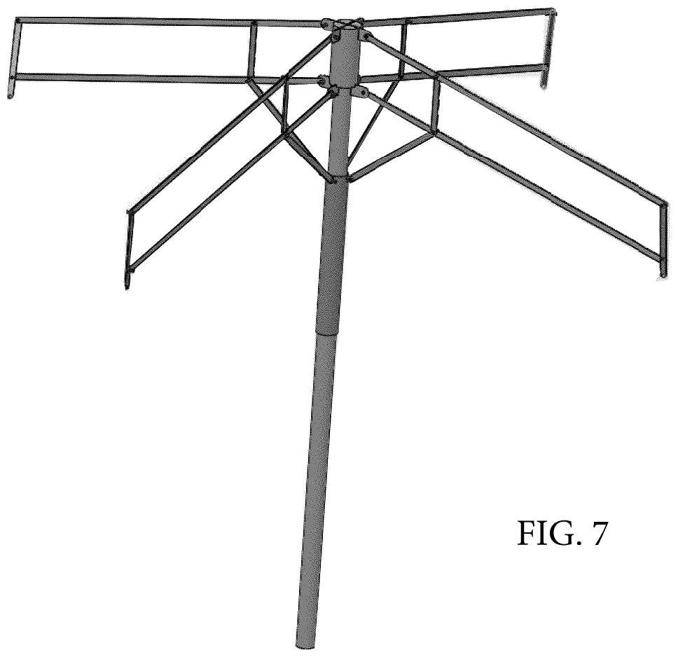

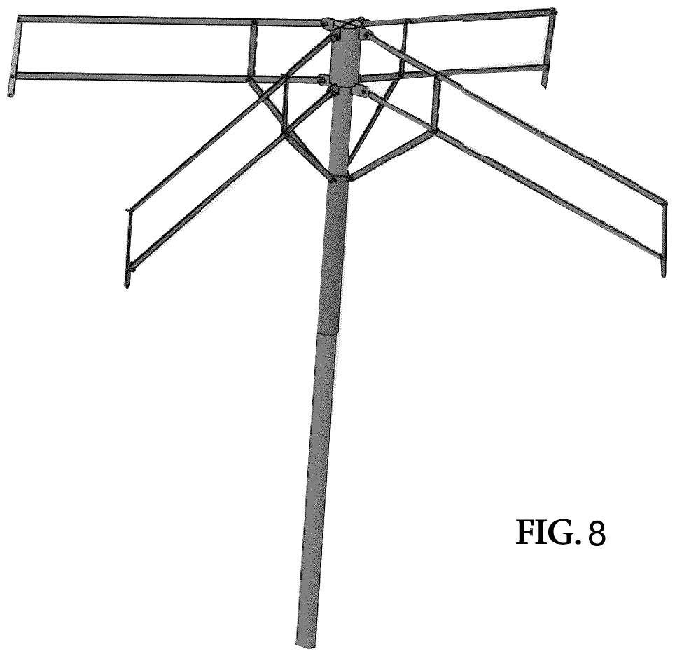

Disclosed is an umbrella or parasol with a framework that operates as a traditional umbrella frame. The details of the improved umbrella or parasol are shown in FIGS. 2 through 8 via depiction of a preferred embodiment. As shown, the depicted framework 1000 includes a first set of spokes (1110) and a second set of spokes (1160) that are connected by a first and second set of risers (1120; 1130) so that the first and second set of spokes (1110; 1160) move in unison to pop-up or collapse the umbrella's canopy (1300). In the preferred embodiment, the disclosed canopy frame (1000) maybe defined by a center pole (1200) with a top hub (1100) and a first set of spokes (1110) pivotally positioned at the top of the center pole (1200), a bottom hub (1150) with a second set of spokes (1160) pivotally positioned at a midpoint of the center pole (1200) below the top hub (1100). Suitably, each spoke of the first set of spokes (1110) is connected to a corresponding spoke in the second set of spokes (1160) via a first riser (1120) that is pivotally connected to the first and second spokes at a midpoint of each spoke and a second riser (1130) that is pivotally connected to the first and second spokes at a distal end of each spoke. In some embodiments the risers can be double risers (i.e., a riser on either side of the spokes) as shown. Preferably, a slidable riser (1140) that movies upward or downward along the center pole (1200) is provided with a set of pivotal lifts (1145) for raising or lowering the first and second set of spokes (1110; 1160). In one embodiment, the slidable riser (1140) is can be a double riser as shown and fit with a locking mechanism to hold the canopy upright when popped. Suitably, a fabric or other sheet-material cover (1300) may be positioned taught over the first set of spokes to form a canopy and folded downward along the second set of risers to form a valance (1310) between each spoke.

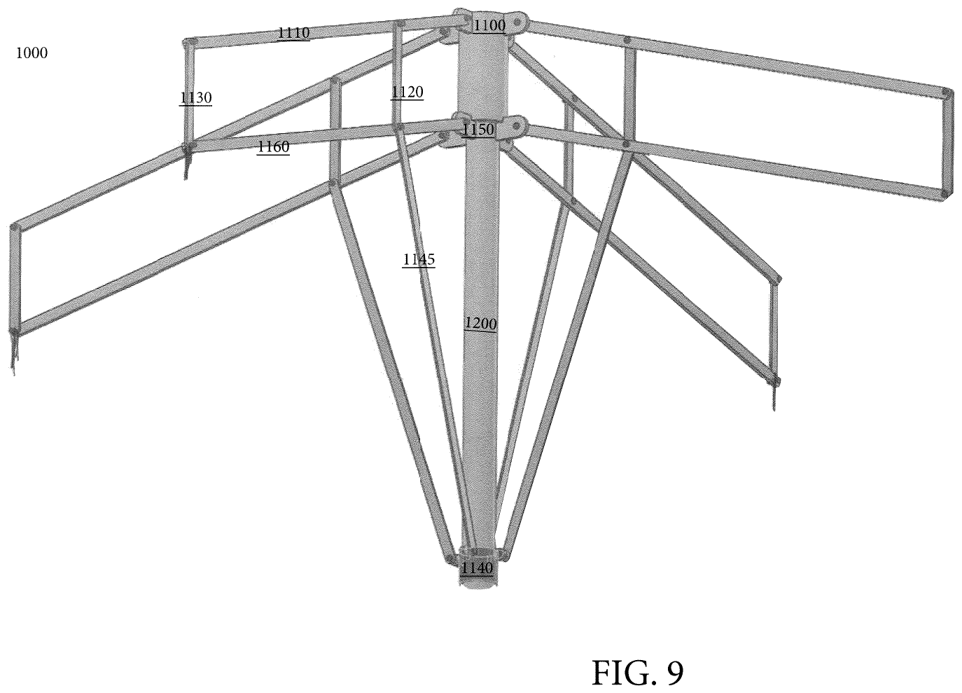

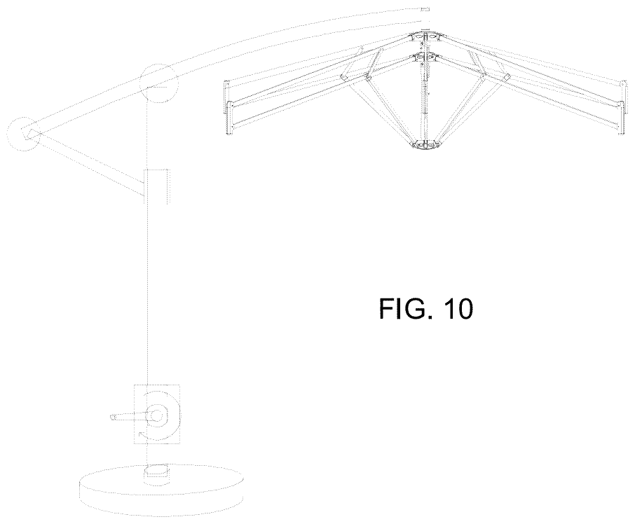

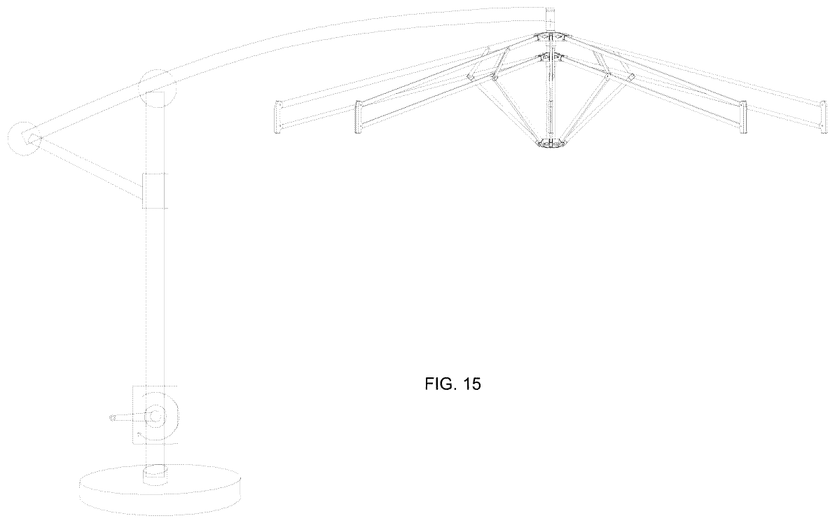

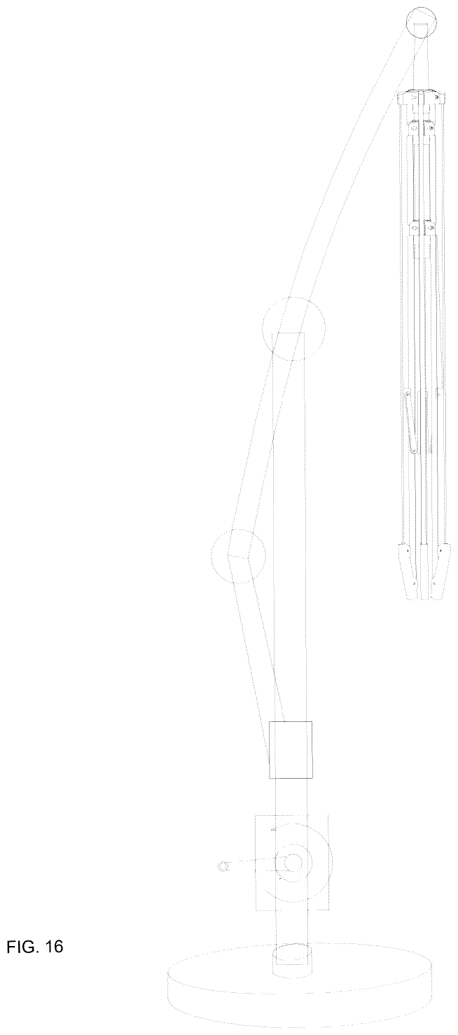

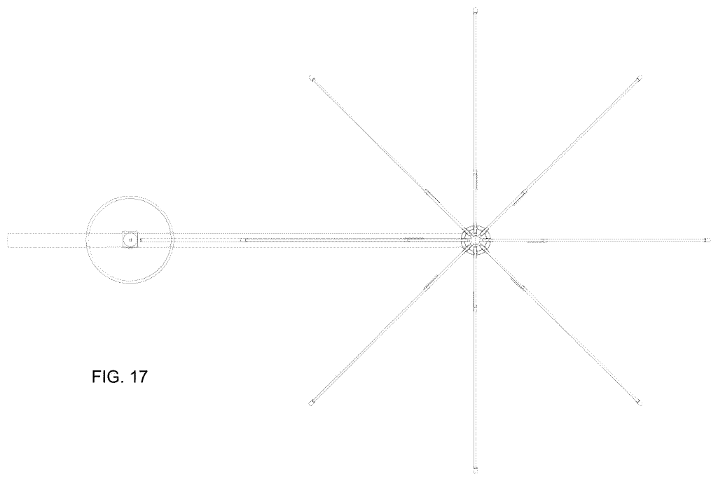

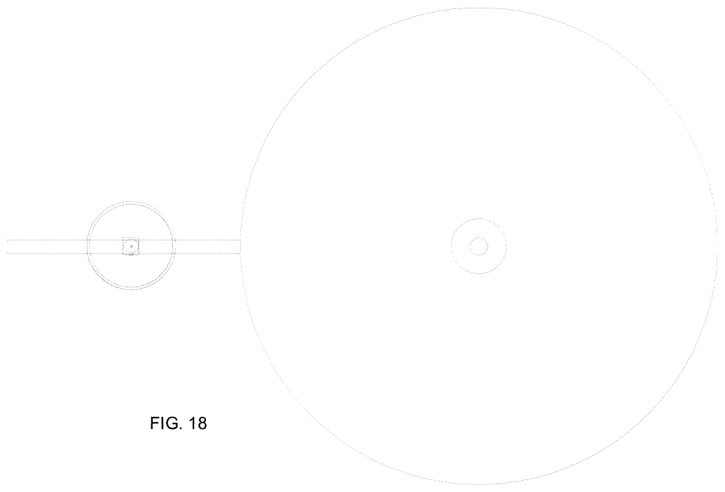

FIG. 9 is the improved umbrella or parasol frame embodied for use in a cantilever style umbrella system, e.g., where the center pole of the umbrella frame is hung up under a cantilever rather than posted on top of an upright. As shown in FIGS. 10 through 12, the improved umbrella or parasol frame with a square plan may be used in a traditional cantilever style umbrella system, e.g., where the center pole of the umbrella frame is hung up under a cantilever rather than posted on top of an upright. As shown in FIGS. 15 through 18 the improved umbrella or parasol frame with a circular plan may be also used in a traditional cantilever style umbrella system. Such cantilever systems can be operated via a crank as is readily understood in the art.

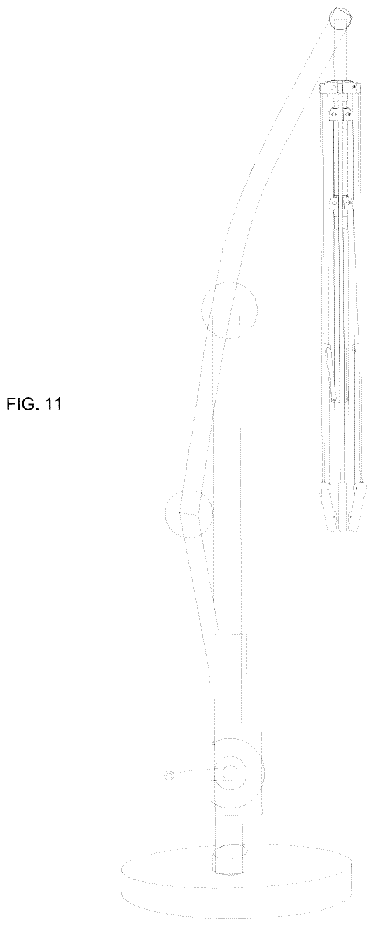

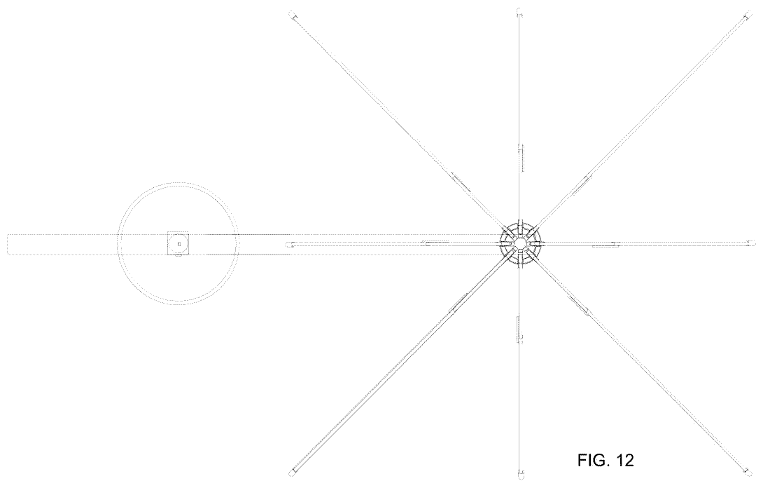

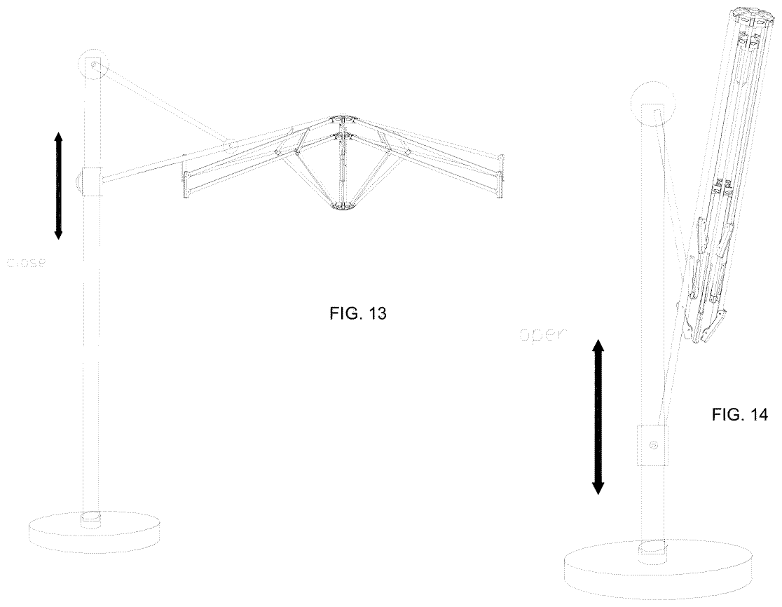

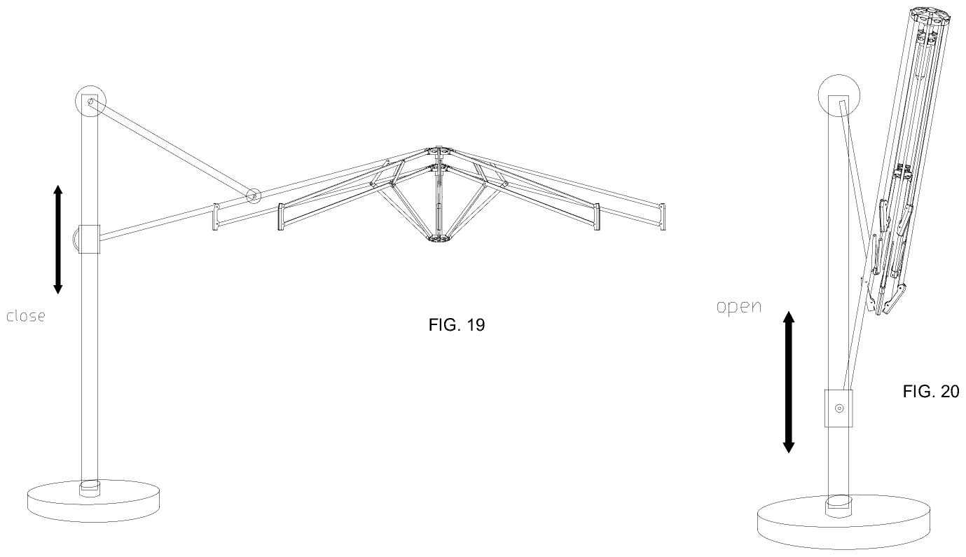

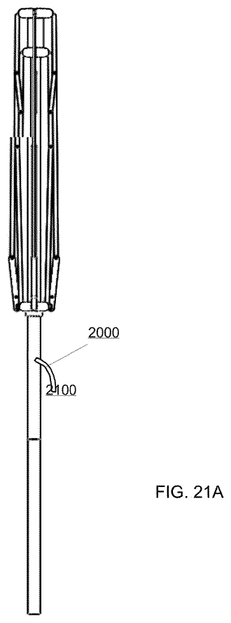

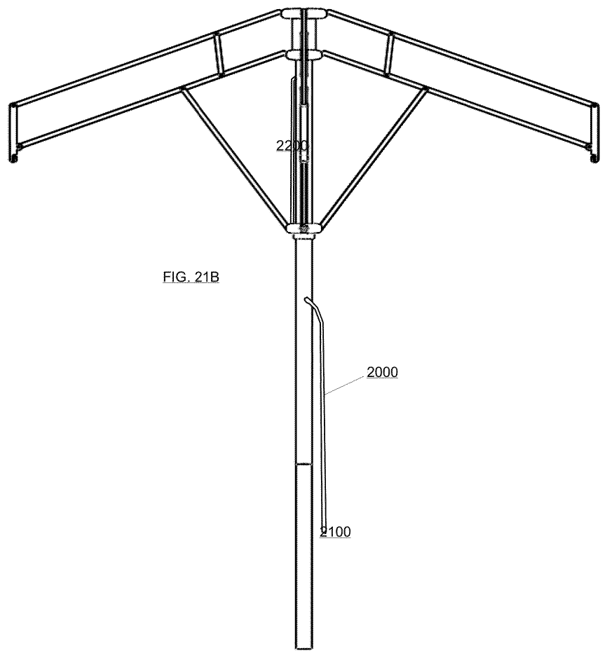

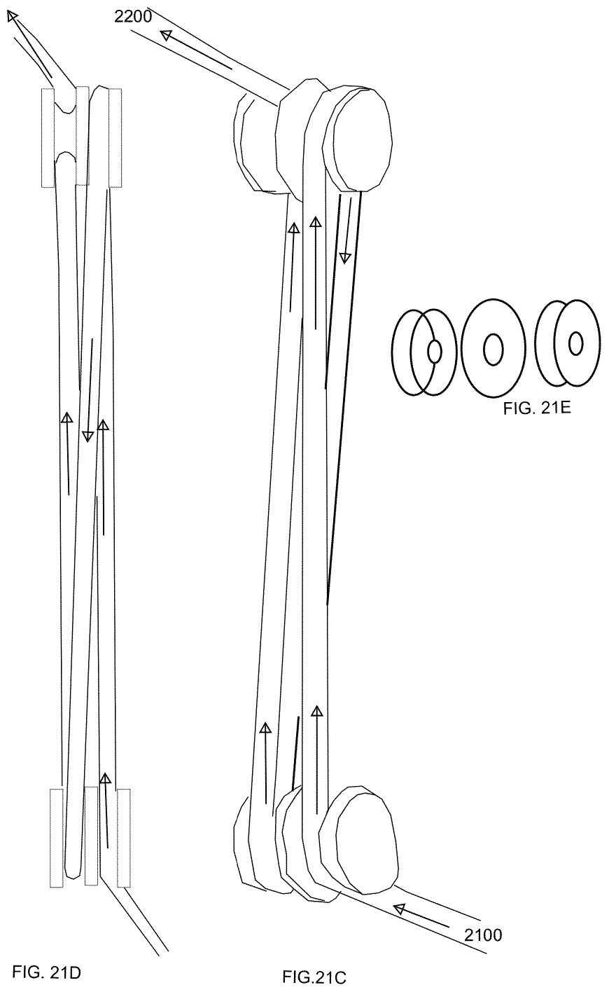

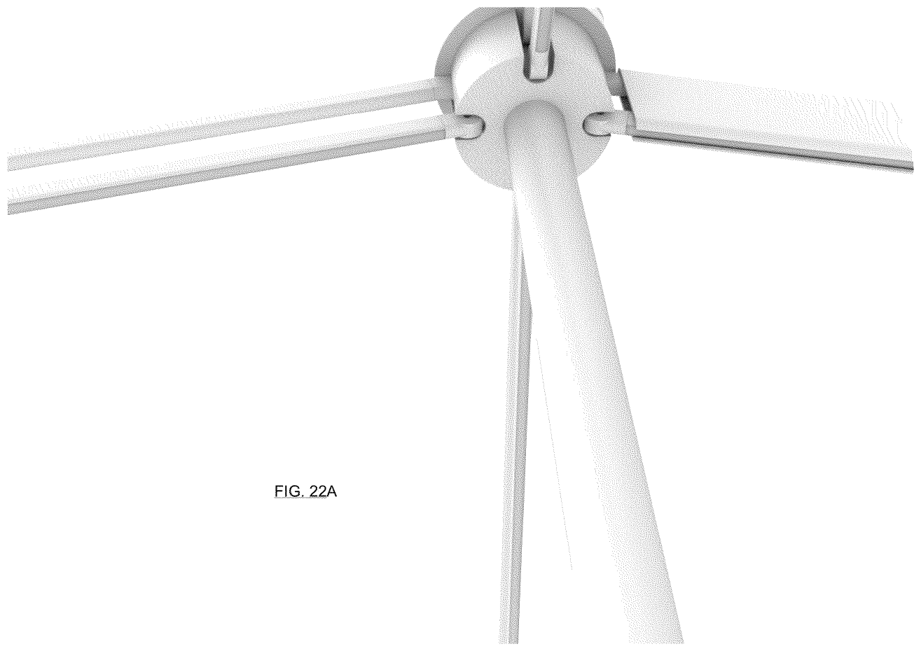

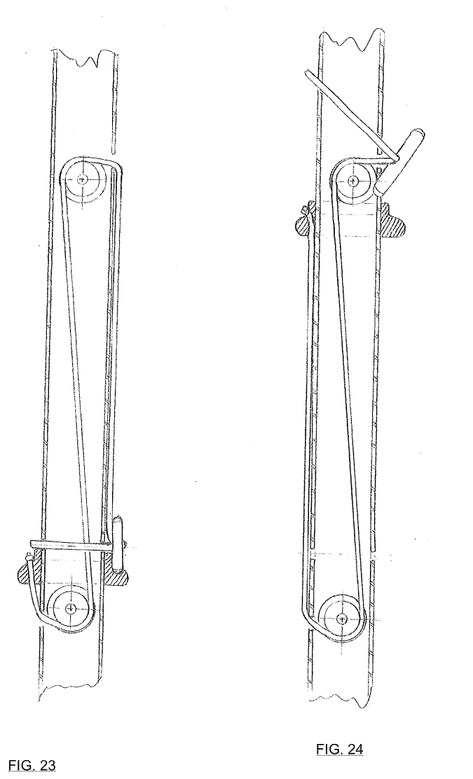

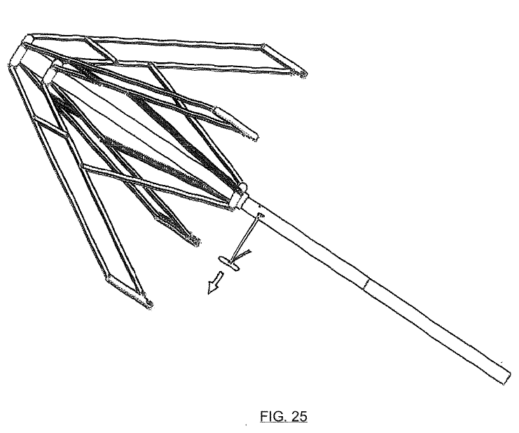

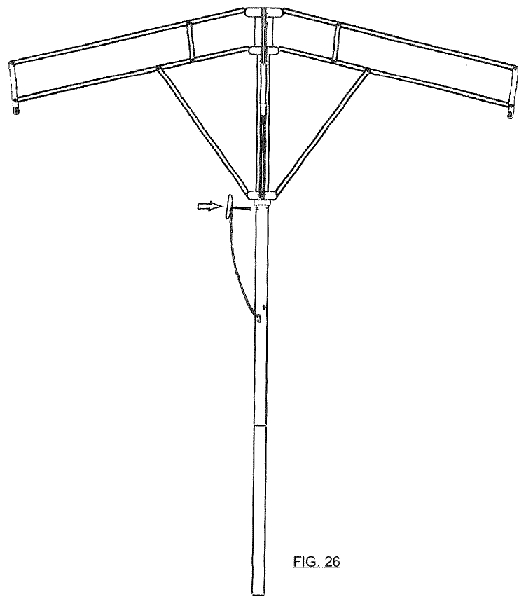

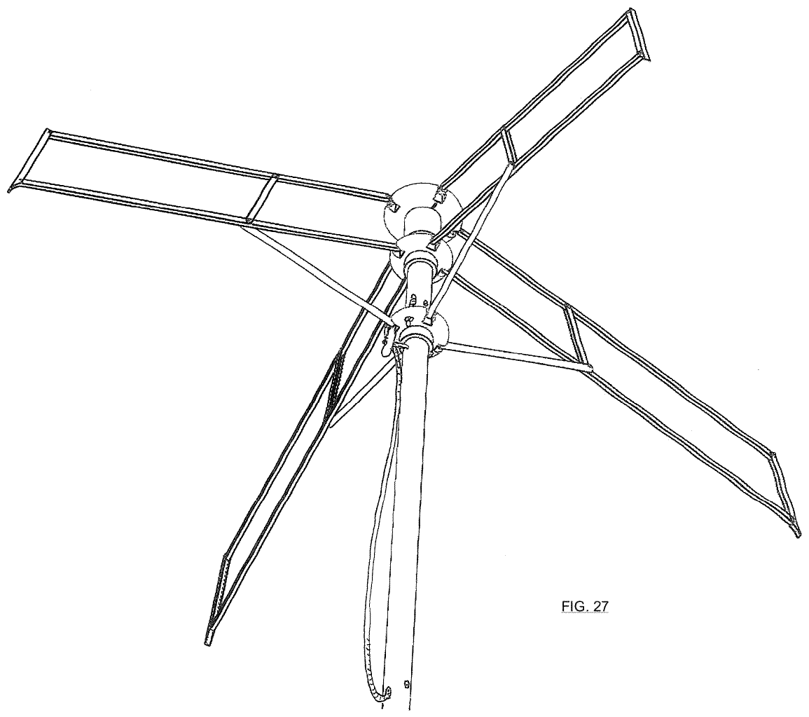

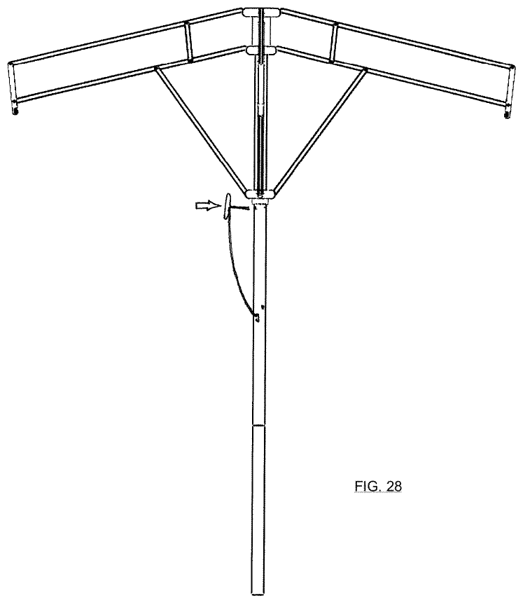

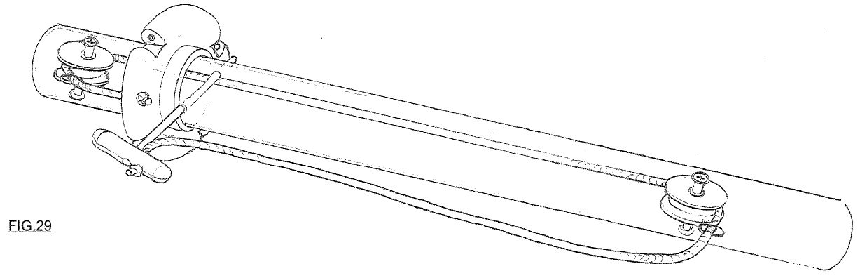

FIGS. 12 and 14 or FIGS. 19 and 20 show views of the improved umbrella or parasol frame with a canopy and a circular or square plan used in a sliding cantilever style umbrella system, e.g., where the center pole of the umbrella frame is hung up under a cantilever rather than posted on top of an upright. As shown, sliding the cantilever base up or down on a pole can cause the cantilever to reach out or pull back. FIG. 21A is an alternate embodiment of the umbrella or parasol framework in a collapsed state. FIG. 21B is the alternate embodiment of the umbrella or parasol framework in a popped up state. As shown, a pull cord (2000) is provided into the pole 1200 with an entrance point at a midpoint of the pole (1200) and exit point at another midpoint of the pole (1200) above sliding the hub (1140). As illustrated by FIGS. 21A and 21B, pulling an end (2100) of the cord (2000) will pull the hub (1140) up the pole (1200) so that the umbrella framework can pop. Suitably, FIG. 21C is a view of the pulley systems for operating the umbrella or parasol via an internal pull cord (2000) to pop-up or collapse the umbrella. FIG. 21D is an alternate view of the pulley system for operating the umbrella or parasol. FIG. 21E is an exploded view of a pulley network of the pulley system of FIGS. 21C and 21D. FIG. 23 is a cross section of a pole with an internal pull cord. FIG. 24 is another cross section of a pole with an internal pull cord. FIG. 25 is a view of an umbrella. FIG. 26 is another view of an umbrella. FIG. 27 is another view of an umbrella. FIG. 28 is another view of the umbrella. FIG. 29 is a perspective view of a center pole with a pully system. As shown, the pull cord can be extended from the center pole and a pin may be used to secure the cord in pulled stated to lock the umbrella in an open or popped up condition.

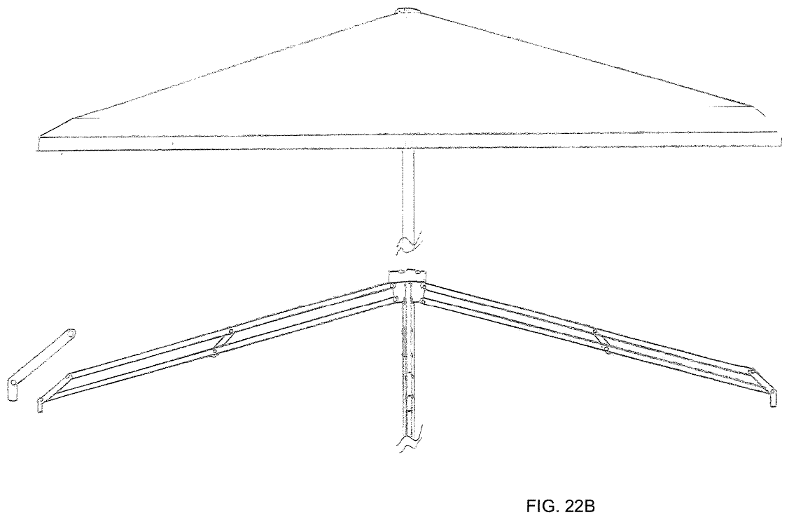

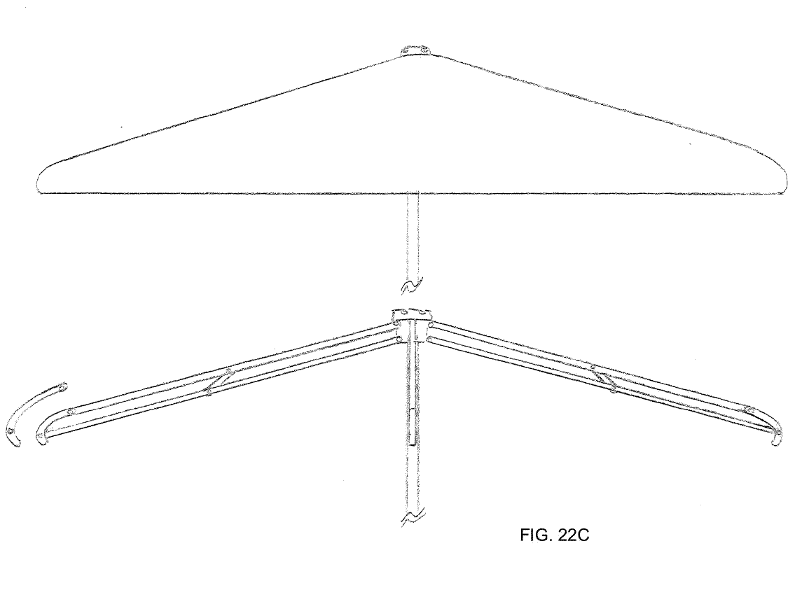

FIG. 22A is another embodiment of the canopy. As shown, the first and second set of spokes are positioned close together. For instance, the spokes may be closer together via placing the risers on an incline or decline relative to the normal direction and adjusting the outer riser to a curve or angular embodiment. See FIGS. 22B and 22C. Also illustrated in FIG. 22A is where the lower set of spokes feature LEDs. Finally, depicted in FIG. 22A is that the spokes feature a sleeve that can be outfitted with advertisements or ornaments.

In use, the umbrella may be popped-up to create a canopy that can include branding or other messaging on the valance. Ideally, the valance of the are pulled tight or taught and provide space for logos, messages, or icons. The ability to avoid valance wind flap In some cases, LED lights could suitably be added to the first or second set of spokes to create an attractive appearance at nighttime. Attachments, such as those disclosed in U.S. patent Ser. No. 11/072,942 (issued Jul. 27, 2021) to Dotterweich, could be used to support accessories that may be desirably secured to the framework.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

1. A covered and collapsible framework of an umbrella or parasol comprising:
a center pole;
a collapsible frame provided on an upper portion of the center pole, said frame featuring:
a first and second set of spokes, each of said first and second set of spokes with at least one spoke that has a tip, a first riser secured to a tip of the at least one spoke of the first set of spokes and a tip of the at least one spoke of the second set of spokes, and a second riser secured to a midpoint of the at least one spoke of the first set of spokes and a midpoint of the at least one spoke of the second set of spokes; and, a cover comprising:
a main body portion that is positioned over the first set of spokes;
first and second valence portions extending from the main body portion such that the tip of the at least one spoke of the first set of spokes is located at a joint of said main body with the first and second valence portions, and the first riser is located at and along a joint of the first and second valence portions;
wherein the first and second valence portions are pulled taught against the first riser whenever the first riser is moved in a radial direction relative to said center pole to uncollapse the collapsible framework.

2. The covered and collapsible framework according to claim 1, where:
each of the first and second sets of spokes comprises at least two spokes where each of the spokes has an inner end portion and tips, the inner end portions of the spokes are pivotably connected to the umbrella shaft, the
first set of spokes located above the second set of spokes;
each of the spokes in the first set of spokes is connected to a corresponding one of the spokes in the second set of spokes via a first set of risers at midpoints of the spokes and a second set of risers at the tips of the spokes.

3. The covered and collapsible framework according to claim 2, where the first set of risers is pivotably connected to the tips of the first and second set of spokes and the second set of risers is pivotably connected to the midpoints of the first and second set of spokes.

4. The sunshade umbrella according to claim 3, characterized in that, the tip of the at least one of the second set of spokes is provided in the joint of the first and second valence portions when the framework is uncollapsed.

5. The covered and collapsible framework according to claim 4 including a pull cord and pully system where pulling the pull cord moves the first riser in the radial direction relative to said center pole to uncollapse the collapsible framework.

6. The covered and collapsible framework according to claim 1, characterized in that, first and second set of spokes are oblique relative to the center pole regardless of whether the framework is collapsed or uncollapsed.

7. The covered and collapsible framework according to claim 6, where the inner end portions of the first and second spokes are respectively higher than the tips thereof.

8. The covered and collapsible framework according to claim 1, where the at least one spoke of the first set of spokes and the at least one spoke of the second set of spokes are parallel to each other.

9. The covered and collapsible framework of claim 5, where the frame further comprises a set of slidable risers wherein at least one of the slidable risers is pivotally connected to a slidable hub on the center pole and a midpoint of the at least one spoke of the second set of spokes.

10. The covered and collapsible framework of claim 9 where the pull cord is connected on one end to the slidable riser such that pulling the pull cord slides the slidable hub so that the slidable riser pivots the at least one spoke of the second set of spokes to move the first riser in the radial direction relative to said center pole to uncollapse the collapsible framework.

11. The covered and collapsible framework of claim 10 where either one or both of the valence portions of the cover include an advertisement.

12. The covered and collapsible framework according to claim 1, characterized in that, the valence portions each forms a plane.

13. The covered and collapsible framework according to claim 12, where the planes formed by the first and second valence portions and axis of the umbrella shaft are parallel to each other.

14. The covered and collapsible framework according to claim 13, the plan of the framework when uncollapsed is circular or parallelogram.

15. The covered and collapsible framework of claim 1 wherein the framework is hoisted by a cantilever.

16. A method of advertising by uncollapsing a covered and collapsible framework according to the following steps:
placing an advertisement on a valence portion of a cover;
placing a cover over collapsed framework so that a main body portion of the cover is positioned over a first set of spokes of the frame work;
wherein the valence portion extends from the main body portion of the cover such that a tip of at least one spoke of the first set of spokes is located at a joint of said main body portion with valence portion, and a first riser that is (a) pivotally connected to both the tip of the at least one spoke of the first set of spokes and a tip of a spoke of a second set of spokes and (b) located at and along an edge of the valence portion;
pulling the valence portion taught against the first riser via keeping the at least one spokes of the first and second sets of spokes separated by a second riser midpoints of the at least one spokes of the first and second sets of spokes and moving the first riser in a radial direction relative to a center pole of the framework to uncollapse the collapsed framework.

17. The method of claim 16 further comprising the step of pulling a pull cord.

18. The method of claim 16 where the first and second risers are double risers.

19. The method of claim 16 further comprising the step of advertising on a panel positioned between the at least one spokes of the first and second set of spokes.

20. A method of uncollapsing a covered and collapsible framework comprising the steps of:
Covering the collapsed framework so that a main body portion of a cover interfaces a first set of spokes of the frame work;
Extending a valence portion from the main body portion of the cover such that a tip of at least one spoke of the first set of spokes is located at a joint of said main body portion with valence portion, and a first riser that is (a) pivotally connected to both the tip of the at least one spoke of the first set of spokes and a tip of a spoke of a second set of spokes and (b) located at and along an edge of the valence portion;
pulling the valence portion taught against the first riser via keeping the at least one spokes of the first and second sets of spokes separated by a second riser midpoints of the at least one spokes of the first and second sets of spokes and moving the first riser in a radial direction relative to a center pole of the framework to uncollapse the collapsed framework.
